(19) United States
(12) Patent Application Publication
(10) Pub. No.: US 2012/0231358 A1
(43) Pub. Date: Sep. 13, 2012

(54) DIRECT OXIDATION FUEL CELL SYSTEM

(76) Inventor: Takashi Akiyama, Osaka (JP)

(21) Appl. No.: 13/509,498

(22) PCT Filed: Nov. 9, 2010
(86) PCT No.: PCT/JP2010/006563

§ 371 Date: May 11, 2012

(30) Foreign Application Priority Data
Nov. 24, 2009 (JP) 2009-266625

(51) Int. Cl. H01M 8/04; H01M 8/06

(52) U.S. Cl. 429/414; 429/434; 429/439; 429/431

(57) ABSTRACT

A direct oxidation fuel cell system includes a fuel cell and a cooling device. An anode-side separator of the fuel cell has a fuel flow channel in the face in contact with the anode. The direction of a flow of air supplied by the cooling device is set so that the upstream-side portion in the average flow direction of fuel in the fuel flow channel is selectively cooled. This allows the upstream-side portion of the polymer electrolyte membrane having large MCO to be cooled, thereby reducing the amount of MCO. Also, the downstream-side portion where the fuel concentration in the fuel flow channel is low has a relatively high temperature, thereby making it possible to improve the energy conversion efficiency.

### TECHNICAL FIELD

This invention relates to a direct oxidation fuel cell system such as a direct methanol fuel cell, and more specifically, to a technique for improving the efficiency of a direct oxidation fuel cell.

### BACKGROUND ART

Fuel cells are classified into polymer electrolyte fuel cells, phosphoric acid fuel cells, alkaline fuel cells, molten carbonate fuel cells, solid oxide fuel cells, etc. according to the kind of the electrolyte used. Among them, polymer electrolyte fuel cells (PEFCs or PEMs) are becoming commercially available as the power source for automobiles, home cogeneration systems, etc, because they operate at low temperatures and have high output densities.

Recently, the use of fuel cells as the power source for portable small electronic devices, such as notebook personal computers, cellular phones, and personal digital assistants (PDAs), has been examined. Fuel cells can generate power continuously if they get refueled. Thus, the use of fuel cells as the power source for portable small electronic devices in place of secondary batteries, which need recharging, is expected to further improve the convenience of portable small electronic devices. Also, PEFCs are suitable as the power source for portable small electronic devices due to the low operating temperature as mentioned above.

Among PEFCs, direct oxidation fuel cells (DOFCs) use a fuel that is liquid at room temperature, and generate electrical energy by directly oxidizing the fuel without reforming it into hydrogen. Hence, direct oxidation fuel cells do not require a reformer and can be miniaturized. Also, among direct oxidation fuel cells, direct methanol fuel cells (DMFCs), which use methanol as the fuel, are superior in energy efficiency and output power to other direct oxidation fuel cells. They are thus regarded as the most promising power source for portable small electronic devices.

The reactions of DMFCs at the anode and the cathode are represented by the following reaction formulae (1) and (2), respectively. Oxygen introduced into the cathode is usually sucked from the air.

Anode: CH₃OH+H₂O→CO₂+6H⁺+6e (1)

Cathode: 3/2O₂+6H⁺+6e⁻→3H₂O (2)

A polymer electrolyte fuel cell such as a DMFC is usually produced by stacking a plurality of cells. Each cell includes a polymer electrolyte membrane and an anode and a cathode disposed so as to sandwich the polymer electrolyte membrane. Each of the anode and the cathode includes a catalyst layer and a diffusion layer, and the anode is supplied with methanol as the fuel while the cathode is supplied with oxygen in the air as the oxidant.

An anode-side separator is disposed so as to come into contact with the anode diffusion layer, and a fuel flow channel for supplying the fuel to the anode is produced, for example, by forming a serpentine groove in the face of the anode-side separator in contact with the anode (see, for example, FIG. 3). Likewise, a cathode-side separator is disposed so as to come into contact with the cathode diffusion layer, and an air flow channel for supplying oxygen to the cathode is produced, for example, by forming a serpentine groove in the face of the cathode-side separator in contact with the cathode.

In direct oxidation fuel cells such as DMFCs, it is important to prevent the fuel supplied to the anode from permeating through the polymer electrolyte membrane, reaching the cathode, and being oxidized at the cathode. This phenomenon in DMFCs is called methanol crossover (MCO), and is a major cause for lowering fuel utilization efficiency. Further, the oxidation reaction of the fuel at the cathode due to MCO conflicts with the reduction reaction of the oxidant (oxygen) at the cathode. As a result, the cathode potential lowers. Thus, MCO can lower the voltage generated and the power generation efficiency.

To reduce MCO, polymer electrolyte membranes that allow little methanol to permeate therethrough are being developed. However, currently available polymer electrolyte membranes are configured to conduct protons through water present in the membranes. Methanol has very high affinity for water. Therefore, in currently available polymer electrolyte membranes, it is difficult in principle to completely prevent methanol from permeating through the polymer electrolyte membrane together with water

With regard to this technical problem, PTL 1 proposes changing the thickness of the anode water-repellent layer contained in the anode diffusion layer between upstream and downstream of the fuel flow channel. More specifically, it proposes increasing the thickness of the anode water-repellent layer upstream of the fuel flow channel and decreasing the thickness of the anode water-repellent layer downstream of the fuel flow channel.

MCO is mainly caused by the difference in methanol concentration between the anode-side surface and the cathode-side surface of the polymer electrolyte membrane. On the anode side, the more upstream of the fuel flow channel, the higher the methanol concentration is. On the cathode side, there is no significant difference in methanol concentration between upstream and downstream of the fuel flow channel. Therefore, the more upstream of the fuel flow channel, the more the amount of MCO is.

PTL 1 intends to suppress MCO by increasing the thickness of the anode water-repellent layer upstream of the fuel flow channel where the amount of MCO is large.

### CITATION LIST

### Patent Literature

PTL 1: Japanese Laid-Open Patent Publication No. 2002-110191

### SUMMARY OF INVENTION

### Technical Problem

However, the anode water-repellent layer is usually approximately 10 to 50 μm, which is very thin. Thus, even when the thickness of the water-repellent layer is somewhat increased, it is practically difficult to suppress MCO.

A more detailed description is given below. The anode water-repellent layer is disposed between the fuel flow channel and the anode catalyst layer. Since the anode water-repellent layer is very thin, there is almost no difference in methanol concentration between both sides of the anode water-repellent layer.

Therefore, considering that MCO is caused by the difference in methanol concentration, even when the thickness of the anode water-repellent layer is somewhat adjusted, the impact on MCO is slight. In particular, when there is a large difference in methanol concentration as upstream of the fuel flow channel, or when the cell temperature is high, the diffusion speed of methanol becomes high. Thus, in such cases, it is more difficult to control MCO by merely adjusting the thickness of the anode water-repellent layer.

MCO is believed to be affected by the temperature of the fuel cell. Also, it is believed that as the temperature lowers, MCO decreases. However, if the temperature of the fuel cell is too low, the power generation efficiency lowers. Further, if the temperature of the fuel cell is lowered, for example, by excessively increasing the flow rate of cooling air supplied by the air-blowing device, a large amount of power is consumed. As a result, the effective output decreases.

It is therefore an object of the invention to effectively prevent the fuel supplied to the anode from permeating through the polymer electrolyte membrane and being oxidized at the cathode, thereby increasing the effective output of the fuel cell.

### Solution to Problem

One aspect of the invention relates to a direct oxidation fuel cell system including:

a fuel cell having at least one unit cell including an anode, a cathode, and a polymer electrolyte membrane interposed therebetween, a fuel inlet portion for introducing a liquid fuel, a fuel outlet portion for discharging a fuel effluent, an oxidant inlet portion for introducing an oxidant, and an oxidant outlet portion for discharging unconsumed oxidant;

a fuel supply unit for supplying the liquid fuel to the anode through the fuel inlet portion;

an oxidant supply unit for supplying the oxidant to the cathode through the oxidant inlet portion; and

a cooling device for cooling the fuel cell so that the temperature of the fuel inlet portion is lower than that of the fuel outlet portion.

Another aspect of the invention relates to a method for controlling a direct oxidation fuel cell system that includes:

a fuel cell having at least one unit cell including an anode, a cathode, and a polymer electrolyte membrane interposed therebetween, a fuel inlet portion for introducing a liquid fuel, a fuel outlet portion for discharging a fuel effluent, an oxidant inlet portion for introducing an oxidant, and an oxidant outlet portion for discharging unconsumed oxidant;

a fuel supply unit for supplying the fuel to the anode through the fuel inlet portion; and

an oxidant supply unit for supplying the oxidant to the cathode through the oxidant inlet portion. This method includes the step (a) of cooling the fuel cell so that the temperature of the fuel inlet portion is lower than that of the fuel outlet portion.

### Advantageous Effects of Invention

The invention can effectively prevent the fuel supplied to the anode from permeating through the polymer electrolyte membrane and being oxidized at the cathode, thereby increasing the effective output of the fuel cell.

### BRIEF DESCRIPTION OF DRAWINGS

FIG. 1 is a perspective view schematically showing the structure of a direct oxidation fuel cell system in one embodiment of the invention;

FIG. 2 is an enlarged sectional view of a part of a fuel cell included in the direct oxidation fuel cell system;

FIG. 3 is a plan view of a membrane electrode assembly of the direct oxidation fuel cell;

FIG. 4 is a graph showing the relationship between the amount of MCO and the temperature of the polymer electrolyte membrane and between the fuel utilization rate and the temperature of the polymer electrolyte membrane of the direct oxidation fuel cell; and

FIG. 5 is a perspective view schematically showing the structure of a direct oxidation fuel cell system in another embodiment of the invention.

### DESCRIPTION OF EMBODIMENTS

This invention relates to a direct oxidation fuel cell system including a fuel cell that has at least one unit cell including an anode, a cathode, and a polymer electrolyte membrane interposed therebetween, a fuel inlet portion for introducing a liquid fuel, a fuel outlet portion for discharging a fuel effluent, an oxidant inlet portion for introducing an oxidant, and an oxidant outlet portion for discharging unconsumed oxidant. This system further includes a fuel supply unit for supplying the fuel to the anode through the fuel inlet portion; an oxidant supply unit for supplying the oxidant to the cathode through the oxidant inlet portion; and a cooling device for cooling the fuel cell so that the temperature of the fuel inlet portion is lower than that of the fuel outlet portion.

The phenomenon of the fuel supplied to the anode permeating through the polymer electrolyte membrane and being oxidized at the cathode (hereinafter described in connection with a DMFC as a representative example of direct oxidation fuel cells unless otherwise specified) is known to be affected by the temperature of the fuel cell, in particular, the polymer electrolyte membrane. As the temperature of the fuel cell or the polymer electrolyte membrane of the unit cell lowers, the diffusion speed of methanol decreases, so the amount of MCO decreases. It should be noted that the invention encompasses a system using a fuel cell consisting only of one unit cell and a system using a fuel cell consisting of a fuel cell stack of unit cells.

Also, as the temperature of the fuel cell rises, the power generation efficiency increases. It should be noted that the temperature range herein does not include such a low temperature range that the fuel cell freezes and such a high temperature range that the mechanism of the fuel cell is destroyed.

MCO is caused by the difference between the anode-side methanol concentration and the cathode-side methanol concentration on both sides of the polymer electrolyte membrane. The methanol concentration in the fuel inlet portion for supplying the fuel to the anode is higher than that in the fuel outlet portion for discharging the fuel effluent. On the cathode side, there is a smaller difference between the methanol concentration in the portion corresponding to the fuel inlet portion and the methanol concentration in the portion corresponding to the fuel outlet portion.

Therefore, the amount of MCO in the fuel inlet portion of the fuel cell is usually larger than the amount of MCO in the fuel outlet portion. As such, according to the invention, the temperature of the fuel inlet portion of the fuel cell is made relatively low to reduce the amount of MCO therein, thereby reducing the amount of MCO in the whole system. Also, the temperature of the fuel outlet portion of the fuel cell where the amount of MCO is small is made relatively high to increase the power generation efficiency therein. As a result, it becomes possible to effectively decrease the amount of MCO in the whole fuel cell to increase the fuel utilization efficiency, while increasing the power generation efficiency of the whole fuel cell. It is thus possible to effectively increase the energy conversion efficiency of the fuel cell system.

Further, in the invention, rather than cooling the whole fuel cell to reduce the amount of MCO, the fuel inlet portion is selectively cooled so that the temperature of the fuel inlet portion is relatively low. This makes it possible to reduce the energy necessary for cooling (e.g., power consumed by the air-blowing device for cooling). It is also possible to suppress a decrease in the effective output of the fuel cell. Also, the reduction of MCO increases the fuel utilization efficiency and the power generation efficiency, thereby enabling a significant improvement in the effective output of the fuel cell.

Examples of the cooling device include the above-mentioned air-blowing device. By disposing the air-blowing device so that it supplies a flow of air in the direction from the fuel inlet portion toward the fuel outlet portion, the fuel cell can be cooled so that the temperature of the fuel inlet portion is lower than that of the fuel outlet portion.

One embodiment of the invention further includes an effluent collecting unit for collecting product water from the oxidant outlet portion and evaporating at least part of the collected product water to discharge it to outside. The effluent collecting unit is adjacent to a portion of the fuel cell close to the fuel inlet portion.

In DMFCs, methanol used as the fuel is usually diluted with water to reduce MCO. To make the size of DMFCs small, it is effective to use the water produced at the cathode (see the above formula (2)) as the water for diluting methanol. Thus, the product water is stored in the effluent collecting unit. The effluent collecting unit can be equipped with a gas-liquid separation film or the like for releasing gases and steam contained in the product water to outside. Further, when the fuel cell system is used as the power source for a portable device, it is not preferable to discharge surplus product water in liquid form to outside. Thus, when the amount of product water stored is excessive, the product water is evaporated through the gas-liquid separation film to prevent the product water from overflowing.

In this embodiment, by disposing the effluent collecting unit adjacent to a portion of the fuel cell close to the fuel inlet portion, that portion is cooled by latent heat released when the product water is evaporated. This makes it possible to effectively cool the fuel inlet portion where the amount of MCO is large. It is thus possible to effectively suppress MCO.

Another embodiment of the invention further includes a first temperature sensor for detecting the temperature of the fuel inlet portion; a second temperature sensor for detecting the temperature of the fuel outlet portion; and an air flow rate controller for setting the flow rate of air supplied by the air-blowing device according to the temperature of the fuel inlet portion and the temperature of the fuel outlet portion detected by the two temperature sensors.

As described above, the amount of MCO decreases when the temperature of the fuel cell or the polymer electrolyte membrane is lowered, and the power generation efficiency of the fuel cell increases when the temperature of the fuel cell or the anode is heightened. Further, when the fuel cell is forcedly cooled by supplying a flow of air to the fuel cell, power is consumed. Therefore, to maximize the effective output of the fuel cell system, it is necessary to optimize the temperatures of the respective portions of the fuel cell. In this embodiment, since the amount of air supplied by the air-blowing device is set based on the detected temperature of the fuel inlet portion and the detected temperature of the fuel outlet portion, the effective output of the fuel cell system can be maximized.

Still another embodiment of the invention further includes a current sensor for detecting the output current of the fuel cell. The air flow rate controller calculates fuel stoichiometry of the fuel cell based on the current value detected by the current sensor, and corrects the set flow rate of air according to the calculated fuel stoichiometry.

The amount of heat generated by the fuel cell changes according to fuel stoichiometry (=flow rate of supplied fuel/amount of fuel contributing to power generation). If the amount of heat generated by the fuel cell changes, the temperature distribution or temperature gradient inside the fuel cell changes slightly. As a result, the target temperature to be achieved by controlling the flow rate of air based on the detected temperatures of the specific points of the fuel cell may deviate from the temperature at which the effective output of the fuel cell can be actually maximized. Thus, when power is supplied to a load for a long period of time, it is necessary to correct the flow rate of air in consideration of fuel stoichiometry. In this embodiment, the set value for the flow rate of air is corrected according to the fuel stoichiometry calculated from the actual output current of the fuel cell. Therefore, the temperatures of the respective portions of the fuel cell can be adjusted easily so that the effective output is maximized.

The fuel cell system further includes a current controller for controlling the output current of the fuel cell so that the output voltage of the fuel cell is a predetermined set voltage. In this case, desirably, the current controller controls the output current of the fuel cell so that the output voltage of the fuel cell is a predetermined set voltage, while the air flow rate controller corrects the set flow rate of air according to the calculated fuel stoichiometry.

The cooling device may be a Peltier device. In this case, a specific portion of the fuel cell can be cooled in a pinpoint manner. It is thus possible to cool only the fuel inlet portion without cooling the fuel outlet portion of the fuel cell.

With respect to the more specific structure of the fuel cell, when the unit cell further includes an anode-side separator in contact with the anode and a cathode-side separator in contact with the cathode, the anode-side separator may be provided with a fuel flow channel having a fuel inlet and a fuel outlet. Further, the cathode-side separator may be provided with an oxidant flow channel having an oxidant inlet and an oxidant outlet. When the fuel cell is a fuel cell stack comprising a stack of a plurality of unit cells, each of the anode-side separator and the cathode-side separator does not need to be an independent component and, for example, one separator plate may be used to provide the functions as the anode-side separator and the cathode-side separator. In this case, one face of the one separator may be provided with a fuel flow channel, while the other face may be provided with a fuel flow channel.

Therein, by making the average flow direction of the liquid fuel in the fuel flow channel parallel to the direction of the flow of air supplied by the air-blowing device, it is possible to effectively make the temperature of the fuel inlet portion relatively low while making the temperature of the fuel outlet portion relatively high. As used herein, “parallel” does not have to be completely parallel, and the two directions may be different as long as the difference is within about 30 degrees. Also, the average flow direction as used herein refers to the direction from upstream toward downstream.

Further, the invention relates to a method for controlling a direct oxidation fuel cell system. This system includes: a fuel cell having at least one unit cell including an anode, a cathode, and a polymer electrolyte membrane interposed therebetween, a fuel inlet portion for introducing a liquid fuel, a fuel outlet portion for discharging a fuel effluent, an oxidant inlet portion for introducing an oxidant, and an oxidant outlet portion for discharging unconsumed oxidant; a fuel supply unit for supplying the fuel to the anode through the fuel inlet portion; and an oxidant supply unit for supplying the oxidant to the cathode through the oxidant inlet portion. This method includes the step (a) of cooling the fuel cell so that the temperature of the fuel inlet portion is lower than that of the fuel outlet portion.

The step (a) is not started, for example, until the temperature of the fuel inlet portion reaches a predetermined temperature after start of operation of the fuel cell. In this case, the fuel cell in the steady state can be controlled.

In the step (a), a flow of air can be supplied in the direction from the fuel inlet portion toward the fuel outlet portion.

The control method can further include the step (b) of detecting the temperature of the fuel inlet portion and the temperature of the fuel outlet portion and setting the flow rate of air according to the detected temperature of the fuel inlet portion and the detected temperature of the fuel outlet portion.

The control method can further include the step (c) of calculating fuel stoichiometry of the fuel cell from the output current and correcting the set flow rate of air according to the calculated fuel stoichiometry.

The unit cell can further include an anode-side separator in contact with the anode and a cathode-side separator in contact with the cathode, as mentioned above. The difference between the temperatures of the fuel inlet portion and the fuel outlet portion is desirably equal to or greater than 0.2° C./cm per unit length in the average flow direction of the fuel in the fuel flow channel.

### Embodiment 1

Embodiments of the invention are hereinafter described with reference to drawings.

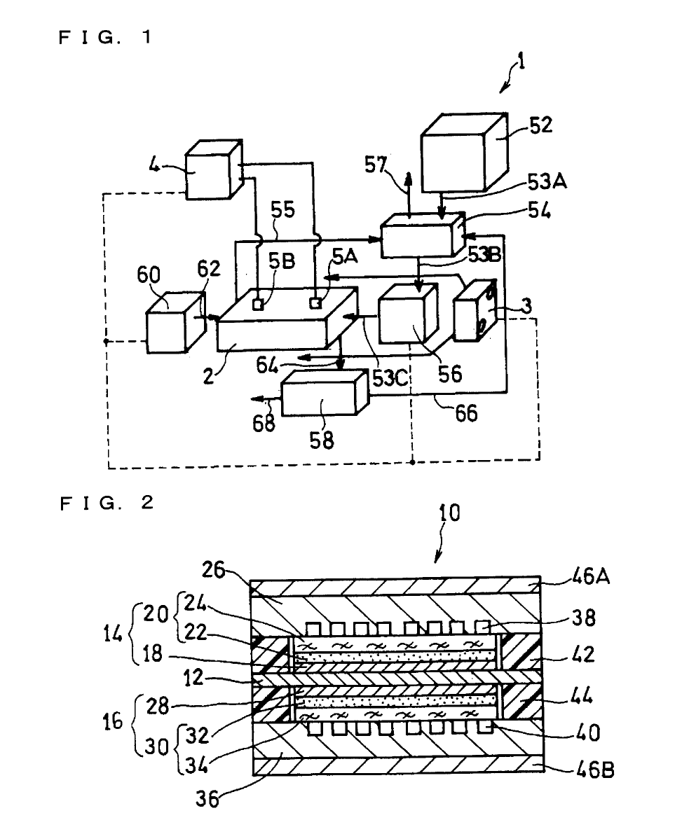

FIG. 1 is a perspective view schematically showing the structure of a fuel cell system in Embodiment 1 of the invention, in which the respective components are simplified. FIG. 2 is an enlarged sectional view of a part of a fuel cell included in the fuel cell system.

A fuel cell is usually used as a fuel cell stack in which a plurality of fuel cells (unit cells) are electrically connected in series. A fuel cell 2 of the fuel cell system of FIG. 1 is also a fuel cell stack comprising a stack of a plurality of unit cells. FIG. 2 illustrates the structure of a unit cell.

A unit cell 10 illustrated therein is a direct methanol fuel cell which includes a polymer electrolyte membrane 12 and an anode 14 and a cathode 16 disposed so as to sandwich the polymer electrolyte membrane 12. The polymer electrolyte membrane 12 has proton conductivity. The anode 14 is supplied with methanol as the fuel. The cathode 16 is supplied with oxygen in the air as the oxidant. A laminate of the anode 14, the cathode 16, and the polymer electrolyte membrane 12 is called an MEA (Membrane Electrode Assembly).

In the laminating direction of the anode 14, the polymer electrolyte membrane 12, and the cathode 16, an anode-side separator 26 is laminated on the outer side of the anode 14 (the upper side in the figure), and an end plate 46A is disposed on the outer side of the anode-side separator 26. Also, in the laminating direction, a cathode-side separator 36 is laminated on the outer side of the cathode 16 (the lower side in the figure), and an end plate 46B is disposed on the outer side of the cathode-side separator 36. When the fuel cell 2 is a fuel cell stack comprising a stack of a plurality of unit cells 10, the end plates 46A and 46B are not provided for each unit cell 10, and each of the end plates 46A and 46B is provided at each end of the fuel cell stack in the stacking direction.

Between the anode-side separator 26 and the polymer electrolyte membrane 12, a gasket 42 is disposed around the anode 14. Between the cathode-side separator 36 and the polymer electrolyte membrane 12, a gasket 44 is disposed around the cathode 16. The gasket 42 prevents the fuel from leaking from the anode 14. The gasket 44 prevents the oxidant from leaking from the cathode 16.

The two end plates 46A and 46B are clamped with bolts, springs, etc., not shown, so as to press the respective separators and the MEA. The interface between the MEA and the anode-side separator 26 and the cathode-side separator 36 has poor adhesion. Thus, the respective separators and the MEA are pressed to increase the adhesion between the MEA and the respective separators, as mentioned above. As a result, the contact resistance between the MEA and the respective separators is reduced.

The anode 14 includes an anode catalyst layer 18 and an anode diffusion layer 20. The anode catalyst layer 18 is in contact with the polymer electrolyte membrane 12. The anode diffusion layer 20 includes an anode porous substrate 24 subjected to a water-repellent treatment, and an anode water-repellent layer 22 formed on a surface thereof and made of a highly water-repellent material. The anode water-repellent layer 22 is in contact with the anode catalyst layer 18.

The cathode 16 includes a cathode catalyst layer 28 and a cathode diffusion layer 30. The cathode catalyst layer 28 is in contact with the face of the polymer electrolyte membrane 12 opposite to the face in contact with the anode catalyst layer 18. The cathode diffusion layer 30 includes a cathode porous substrate 34 subjected to a water-repellent treatment, and a cathode water-repellent layer 32 formed on a surface thereof and made of a highly water-repellent material. The cathode water-repellent layer 32 is in contact with the cathode catalyst layer 28.

A laminate comprising the polymer electrolyte membrane 12, the anode catalyst layer 18, and the cathode catalyst layer 28 is the power generation area of the fuel cell, which is called a CCM (Catalyst Coated Membrane). Thus, the MEA is a laminate of the CCM, the anode diffusion layer 20 and the cathode diffusion layer 30. The anode diffusion layer 20 and the cathode diffusion layer 30 have the functions of uniformly diffusing the fuel and oxidant supplied to the plane directions of the anode 14 and the cathode 16, respectively, as well as the function of smoothly removing the products of the cell reaction, i.e., water and carbon dioxide.

The face of the anode-side separator 26 in contact with the anode porous substrate 24 has a fuel flow channel 38 for supplying the fuel to the whole anode 14. The fuel flow channel 38 is produced by, for example, providing the above-mentioned contact face with a recess or groove which is open toward the anode porous substrate 24. When the fuel cell 2 is a fuel cell stack comprising a stack of a plurality of unit cells 10, the other face of the anode-side separator 26 may be provided with an air flow channel 40. That is, one separator plate may be used to provide the functions as the anode-side separator and the cathode-side separator.

The face of the cathode-side separator 36 in contact with the cathode porous substrate 34 has the air flow channel 40 for supplying the oxidant (oxygen) to the whole cathode 16. The air flow channel 40 can also be produced by, for example, providing the above-mentioned contact face with a recess or groove which is open toward the cathode porous substrate 34. When the fuel cell 2 is a fuel cell stack comprising a stack of a plurality of unit cells 10, the other face of the cathode-side separator 36 may be provided with the fuel flow channel 38. That is, one separator plate may be used to provide the functions as the anode-side separator and the cathode-side separator.

The fuel flow channel 38 and the air flow channel 40 may be formed afterward, for example, by cutting a groove in a surface of the separator, or may be formed simultaneously with the formation (injection molding, compression molding, etc.) of the separator.

The anode catalyst layer 18 includes anode catalyst particles for promoting the reaction of the reaction formula (1) and a polymer electrolyte for providing ionic conductivity between the anode catalyst layer 18 and the polymer electrolyte membrane 12. Examples of the polymer electrolyte contained in the anode catalyst layer 18 include a perfluorosulfonic acid/tetrafluoroethylene copolymer (H⁺ type), sulfonated polyether sulfone (H⁺ type), and aminated polyether sulfone (OH⁻ type).

The anode catalyst particles can be supported on a support comprising conductive carbon particles such as, for example, carbon black. The anode catalyst particles can be formed of an alloy containing platinum (Pt) and ruthenium (Ru) or a mixture of Pt and Ru. In order to increase the active sites of the anode catalyst particles and heighten the reaction speed, it is preferable to make the size of the anode catalyst particles as small as possible for use. The mean particle size of the anode catalyst particles can be set to 1 to 20 nm.

The cathode catalyst layer 28 includes a cathode catalyst for promoting the reaction of the reaction formula (2) and a polymer electrolyte for providing ion conductivity between the cathode catalyst layer 28 and the polymer electrolyte membrane 12.

Examples of the cathode catalyst contained in the cathode catalyst layer 28 include Pt simple substance and Pt alloys. Examples of Pt alloys include alloys of Pt and transition metals such as cobalt and iron. Such Pt simple substance or Pt alloys may be used in the form of fine powders, or may be supported on a support comprising conductive carbon particles such as, for example, carbon black.

The polymer electrolyte contained in the cathode catalyst layer 28 can be any material mentioned as the polymer electrolyte contained in the anode catalyst layer 18.

As the material of the polymer electrolyte membrane 12, various polymer electrolyte materials known in the art can be used. Most of the currently available polymer electrolyte membranes are proton-conductive electrolyte membranes.

Examples of the polymer electrolyte membrane 12 include fluoropolymer membranes. Examples of fluoropolymer membranes include polymer membranes including a perfluorosulfonic acid polymer such as a perfluorosulfonic acid/tetrafluoroethylene copolymer (H⁺ type). An example of such a polymer membrane including a perfluorosulfonic acid polymer is a Nafion membrane (trade name: “Nafion®”, available from E.I. Dupont de Nemours and Company).

The polymer electrolyte membrane 12 is preferably one capable of suppressing the crossover of the fuel (such as methanol) used in direct oxidation fuel cells. Examples of polymer electrolyte membranes having such an effect include the above-mentioned fluoropolymer membranes, membranes comprising a fluorine-atom-free hydrocarbon polymer such as sulfonated polyether ether sulfone (S-PEEK), and composite membranes comprising inorganic and organic material.

Examples of porous substrates used as the anode porous substrate 24 and the cathode porous substrate 34 include carbon paper comprising carbon fibers, carbon cloth, carbon non-woven fabric (carbon felt), corrosion-resistant metal mesh, and metal foam.

Examples of highly water-repellent materials used to form the anode water-repellent layer 22 and the cathode water-repellent layer 32 include fluoropolymers and fluorinated graphite. An example of a fluoropolymer is polytetrafluoroethylene (PTFE).

The anode-side separator 26 and the cathode-side separator 36 can be formed of a conductor, for example, a carbonaceous material such as graphite. The anode-side separator 26 and the cathode-side separator 36 function as partitions for blocking circulation of chemical substances between the unit cells, and function as connectors for providing electronic conduction between the unit cells and connecting the respective unit cells in series.

Examples of materials of the gaskets 42 and 44 include fluoropolymers such as polytetrafluoroethylene (PTFE) and tetrafluoroethylene-hexafluoropropylene copolymer (FEP), synthetic rubbers such as fluorocarbon rubber and ethylene-propylene-diene rubber (EPDM), and silicone elastomers.

Each of the gaskets 42 and 44 can be produced by providing a central part of a sheet made of PTFE or the like with an opening for receiving the membrane electrode assembly (MEA), the opening being as large as the MEA. The gaskets 42 and 44 are disposed on the surfaces of the polymer electrolyte membrane 12 so that the inner edge of the opening faces the outer edge of the anode catalyst layer 18 or the cathode catalyst layer 28.

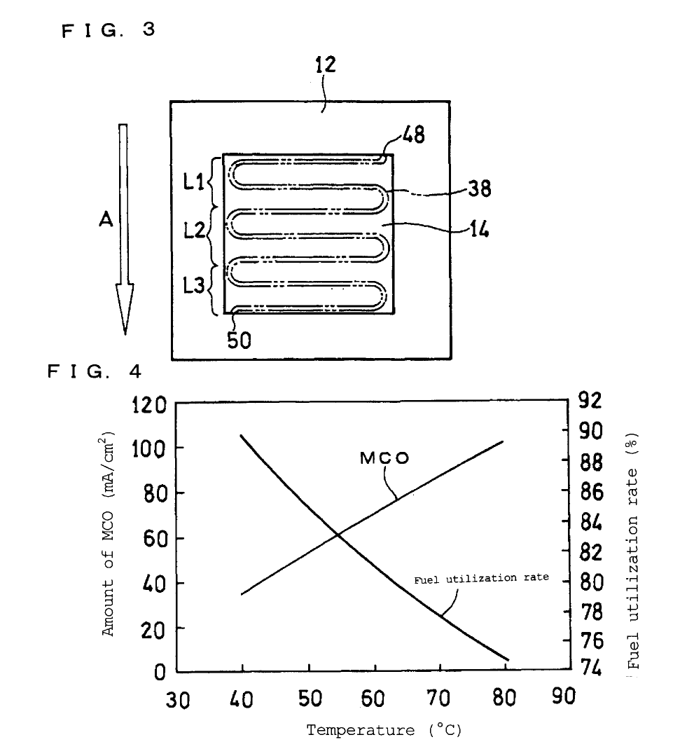

Referring now to FIG. 3, the fuel flow channel is described.

FIG. 3 is a plan view of the MEA viewed from the anode side. In FIG. 3, the fuel flow channel 38 formed in the anode-side separator 26 so as to face the anode 14 is shown by an imaginary line (dot-dot dashed line).

As illustrated in FIG. 3, the fuel flow channel 38 is formed in the portion of the anode-side separator 26 facing the anode 14 (anode porous substrate 24) such that it is serpentine and travels longitudinally or laterally therethrough. This structure allows the fuel to be distributed in the plane direction of the anode 14. The fuel flow channel 38 has at least one fuel inlet and at least one fuel outlet. As used herein, the fuel inlet portion refers to a portion of the separator (anode-side separator 26, or an integral anode-cathode separator) on the fuel inlet side. The fuel outlet portion refers to a portion of the separator on the fuel outlet side.

In the unit cell 10 of the illustrated example, the fuel flow channel 38 has only one fuel inlet 48 and one fuel outlet 50 for the sake of simplicity. The fuel flows in one direction from the fuel inlet 48 toward the fuel outlet 50. In the fuel flow channel 38 illustrated in FIG. 3, the average flow direction of the fuel is the direction of the arrow A. It should be noted that the invention encompasses the cases in which the fuel cell has a plurality of fuel flow channels or a branched fuel flow channel.

The fuel cell system of the invention including the fuel cell 2 is hereinafter described.

The fuel cell system 1 of FIG. 1 is equipped with the fuel cell 2, a cooling device 3, a control unit 4, a fuel tank 52, a mixing tank 54, a fuel pump 56, a water collecting unit 58, and an air pump 60.

The control unit 4 can be composed of a CPU (Central Processing Unit), an MPU (Micro Processing Unit: microprocessor), memory, etc. An adjusting device for adjusting the output current of the fuel cell 2 to adjust the output voltage of the fuel cell, such as a DC/DC converter, can be provided between the output terminals of the fuel cell 2 and a load device (not shown).

When the cooling device 3 is an air-blowing device, the control unit 4 includes an air flow rate controller (not shown) for setting the flow rate of air supplied by the air-blowing device and a current controller for controlling the output current of the fuel cell 2 so that the output voltage of the fuel cell 2 is a predetermined set voltage. The air flow rate controller and the current controller can be realized, for example, by the CPU performing a computation according to a predetermined algorithm. The air flow rate controller and the current controller can be provided independently of the control unit 4.

The fuel tank 52 stores methanol as the fuel. The fuel stored in the fuel tank 52 is supplied to the anode 14 of the fuel cell 2 by the fuel pump 56. The fuel to be supplied to the fuel cell 2 is transported to the mixing tank 54 through a fuel pipe 53A before it is supplied to the fuel cell 2.

In the mixing tank 54, the fuel from the fuel tank 52, the water collected from the effluent from the cathode 16 of the fuel cell 2 by the water collecting unit 58 and transported through a water collection pipe 66, and the fuel effluent (containing a thin aqueous methanol solution) from the anode 14 are mixed together. Thus, the fuel methanol is diluted. As a result, the methanol and water mixed in the mixing tank 54, i.e., an aqueous methanol solution, is supplied to the fuel cell 2 via a fuel pipe 53B, the fuel pump 56, and a fuel pipe 53C. The reason why methanol is diluted is that if high concentration methanol is supplied to the anode 14, the amount of methanol crossover (MCO) increases significantly.

Of the fuel transported to the anode 14 of the fuel cell 2, surplus fuel is returned as an aqueous methanol solution to the mixing tank 54 through a fuel collection pipe 55 without being consumed by the fuel cell 2. Carbon dioxide produced at the anode 14 is returned to the mixing tank 54 together with the aqueous methanol solution through the fuel collection pipe 55, separated by a gas-liquid separation film (not shown) disposed in the mixing tank 54, and discharged to outside through a carbon dioxide discharge path 57.

The air containing oxygen as the oxidant is supplied to the cathode 16 of the fuel cell 2 by the air pump 60 through an air pipe 62. At the cathode 16, water is produced. Thus, of the air transported to the cathode 16, surplus air is mixed with the product water and discharged to the water collecting unit 58 as a gas-liquid mixture through a water outlet pipe 64.

The water collecting unit 58 is composed of, for example, a container having an upper opening and a gas-liquid separation film (not shown) closing the opening. The water and air contained in the gas-liquid mixture are separated by the gas-liquid separation film of the water collecting unit 58. Part of the water separated by the water collecting unit 58 is stored in the water collecting unit 58 to dilute methanol, and transported to the mixing tank 54 through the water collection pipe 66 when necessary. Further, the water collecting unit 58 has a water volume sensor (not shown) for detecting the amount of water stored. The signal detected by the water volume sensor is sent to the control unit 4.

When the control unit 4 detects from the signal detected by the water volume sensor that excessive water is stored in the water collecting unit 58 due to, for example, continuous operation for a long time, the control unit 4 controls the air pump 60 and the like so that a larger flow rate of air flows into the water collecting unit 58 or the vicinity of the gas-liquid separation film, to increase the amount of water evaporation. This allows the water to be dissipated from the system as steam to prevent the water collecting unit 58 from overflowing. As described above, the water collecting unit 58 stores a certain amount of water, and it therefore has the function of supplying necessary water when the circulating water for diluting methanol becomes insufficient.

In the system of FIG. 1, the unit cells 10 of the fuel cell 2 are stacked vertically in the figure. Also, in each unit cell 10, the fuel inlet 48 of the fuel flow channel 38 is positioned on the right side of the figure, while the fuel outlet 50 is positioned on the left side of the figure.

The cooling device 3 performs the temperature distribution control function alone or in cooperation with the control unit 4, so that the temperature distribution of the fuel cell 2 is controlled to achieve a desired distribution. In the system of FIG. 1, the cooling device 3 comprises an air-blowing device. When the flow rate of air supplied by the air-blowing device is set to a predetermined amount and the temperature distribution of the fuel cell 2 is controlled only by adjusting the installation position, orientation, and air flow direction of the air-blowing device, the cooling device 3 alone performs the control function. When the control unit 4 has an air flow rate controller for setting the flow rate of air supplied by the air-blowing device to achieve a more preferable temperature distribution, the cooling device 3 and the control unit 4 cooperate to perform the control function. It is also possible for the cooling device 3 to include an air flow rate controller.

The air-blowing device may be a fan such as a sirocco fan, a turbo fan, an axial fan, or a cross-flow fan, a blower such as a centrifugal blower, an axial blower, or a positive displacement blower, or a fan motor. It is preferable that the air-blowing device consume less power and produce larger pressure and a larger flow rate of air. In particular, when the air-blowing device is used in a fuel cell system for a mobile device, it preferably produces less noise and vibration.

Also, the cooling device 3 can be a liquid-cooling type cooling device that cools the respective unit cells by passing a refrigerant such as cooling water inside the respective separators. The invention encompasses such cases. However, such a cooling device requires a pump for supplying the refrigerant, a radiator for cooling the refrigerant, etc. Thus, the cooling mechanism usually consumes large power, and the mechanism is large. Therefore, for use as the power source for mobile or other devices which require miniaturization, the cooling device is preferably an air cooling type one which can be easily miniaturized.

Generally, fuel cells generate heat in the process of power generation. Thus, fuel cells usually need to be cooled. When the fuel cell stack is cooled by a flow of air supplied by the air-blowing device, the direction of the flow of air is made perpendicular to the stacking direction of the fuel cell stack, in order to cool the respective unit cells as evenly as possible. In the fuel cell system 1 of FIG. 1, the direction of the flow of air supplied by the cooling device 3 is also perpendicular to the stacking direction of the unit cells 10 of the fuel cell 2.

Further, generally, a liquid fuel of room temperature is supplied to a fuel cell through a fuel flow channel as illustrated in FIG. 3. Thus, the portion of the fuel cell upstream of the fuel flow channel is cooled more by the fuel. Therefore, the temperature of that portion becomes lower than that of the portion downstream of the fuel flow channel.

As such, in terms of making the temperature distribution of the fuel cell as evenly as possible, in the case of cooling the fuel cell by a flow of air supplied by an air-blowing device, it is common in conventional art to supply the flow of air to the fuel cell from the downstream side of the fuel flow channel.

However, in the system 1 of the illustrated example, the cooling device 3 (air-blowing device) is disposed so that the portion of each unit cell 10 of the fuel cell 2 upstream of the fuel flow channel 38 (on the right side in the figure) is selectively cooled. In FIG. 1, the fuel pump 56 is illustrated as being positioned between the air-blowing device 3 and the fuel cell 2, but in fact the fuel pump 56 is disposed so as not to interfere with the supply of air by the air-blowing device 3.

By disposing the cooling device 3 in the system 1 of the illustrated example as described above, the fuel cell 2 is cooled so that the portion of each unit cell 10 upstream of the fuel flow channel 38 has a lower temperature than the portion downstream, compared with the conventional art.

The amount of MCO tends to decrease as the temperature of the polymer electrolyte membrane 12 lowers, as shown in FIG. 4. Therefore, by lowering the temperature of the polymer electrolyte membrane 12 upstream of the fuel flow channel 38 where MCO increases due to high methanol concentration, the MCO in the whole fuel cell 2 can be effectively suppressed.

In the system of FIG. 1, in the portion of the fuel cell 2 downstream of the fuel flow channel 38, the temperature of each unit cell 10, more specifically, the temperature of the anode 14, is kept relatively high. As a result, the diffusion of the fuel increases, thereby decreasing the diffusion overvoltage. Also, the activity of the catalyst increases, thereby decreasing the reaction overvoltage. Thus, the fuel cell 2 as a whole can generate high voltage.

A more detailed description is given below. The movement of methanol inside the polymer electrolyte membrane 12 is due mainly to concentration diffusion and electroosmosis. Thus, the amount of MCO is significantly dependent on the difference in methanol concentration between the anode-side surface and the cathode-side surface of the polymer electrolyte membrane 12. The methanol concentration on the cathode-side surface of the polymer electrolyte membrane 12 is believed to be negligibly small since the crossover methanol is promptly oxidized at the cathode 16. Thus, after all, the amount of MCO is determined by the methanol concentration on the anode-side surface of the polymer electrolyte membrane 12.

Further, the diffusion of the fuel supplied through the fuel flow channel 38 in the plane direction of the anode 14 is suppressed by the diffusion resistance of the anode water-repellent layer 24. The fuel supplied to the anode 14 is immediately consumed by the oxidation reaction in the anode catalyst layer 18. Thus, the distribution of methanol concentration in the thickness direction of the anode 14 is usually such that the methanol concentration on the surface of the polymer electrolyte membrane 12 on the anode 14 side is very small, compared with the methanol concentration in the fuel flow channel 38.

Also, the distribution of methanol concentration in the fuel flow channel 38 in the plane direction of the anode 14 is such that the methanol concentration is highest at the inlet of the fuel flow channel 38 and lowest at the outlet of the fuel flow channel 38. As a result, on the surface of the polymer electrolyte membrane 12 on the anode 14 side, the portion upstream of the fuel flow channel 38 has a relatively high methanol concentration. Therefore, the amount of MCO is large in the portion of the polymer electrolyte membrane 12 upstream of the fuel flow channel 38.

As such, with respect to the power generation efficiency of the respective portions of the MEA or CCM in the plane direction thereof, the largest decrease in power generation performance due to MCO occurs in the ⅙ to ⅓ portion upstream of the fuel flow channel 38. With reference to FIG. 3 as an example, that portion of the MEA is designated as an upstream portion L1. Likewise, the ⅙ to ⅓ portion of the MEA downstream of the fuel flow channel 38 is designated as a downstream portion L3, and the portion between the upstream portion L1 and the downstream portion L3 is designated as a midstream portion L2.

As described above, downstream of the fuel flow channel 38, the fuel concentration in the fuel flow channel 38 is very low, compared with upstream. Thus, in the anode 14 in the downstream portion L3, voltage decrease due to concentration overvoltage needs to be reduced to suppress output decrease. Thus, in the anode 14 in the downstream portion L3, the diffusion of the fuel in the anode catalyst layer 18 needs to be enhanced to make the methanol concentration in the anode catalyst layer 18 uniformly high.

Also, the force causing MCO increases as the temperature rises. This is because as the temperature rises, the concentration diffusion coefficient and the electroosmosis coefficient (the number of solvent molecules having moved per unit number of ions having moved) increase. Therefore, the amount of MCO is significantly dependent on the temperature of the polymer electrolyte membrane. As such, by lowering the temperature of the polymer electrolyte membrane 12 upstream of the fuel flow channel 38 where MCO increases due to high methanol concentration, the amount of MCO in the whole fuel cell 2 can be effectively suppressed.

FIG. 4 shows an example of the relationship between the amount of MCO and the temperature of the polymer electrolyte membrane and the relationship between the fuel utilization rate and the anode temperature. In this example, the projected area of the electrodes (anode and cathode) of the fuel cell is 36 cm², the concentration of the fuel supplied to the fuel cell is 4M, the fuel stoichiometry is 1.7, and the current density of the fuel cell is 300 mA/cm².

The fuel stoichiometry Fsto is a coefficient obtained by dividing the amount of fuel supplied to the anode by the amount of fuel converted from the value of current generated, i.e., the amount of fuel actually used to generate power, and it is given by the following formula (3):

Fsto=(I1+I2)/I1 (3)

wherein I1 is the current generated and I2 is the value of current converted from the sum of the amount of unconsumed fuel and the amount of crossover fuel.

Also the fuel utilization rate Futi can be given by the following formula (4):

Futi=I1/(I1+IMCO) (4)

wherein IMCO is the value of current converted from the amount of crossover fuel.

FIG. 4 shows that the amount of MCO increases as the temperature of the polymer electrolyte membrane 12 rises. On the other hand, the fuel utilization rate Futi decreases as the temperature of the polymer electrolyte membrane 12 rises. Therefore, the energy conversion efficiency lowers as the temperature of the polymer electrolyte membrane 12 rises.

However, generally, the reaction overvoltage of the electrodes (anode 14 and cathode 16) tends to decrease as the temperature rises. Thus, as the temperature of the electrodes rises, the voltage generated becomes higher. Therefore, the two requirements of having to reduce the amount of MCO and having to increase the voltage generated cannot be satisfied by merely heightening the temperature of the MEA or merely lowering it.

In the fuel cell system 1 of the illustrated example, the temperature of the polymer electrolyte membrane 12 in the upstream portion L1 is made relatively low to suppress MCO. At the same time, the temperature of the anode 14 in the downstream portion L3 is made relatively high to increase the voltage generated. In this manner, the two requirements of having to reduce the amount of MCO and having to increase the voltage generated are satisfied at the same time.

Further, in order to make the temperatures of the respective unit cells of the fuel cell 2 uniform in the plane direction of the polymer electrolyte membrane 12, it is necessary to cool the fuel cell 2 by a larger flow rate of air. This requires more power. However, in the system of FIG. 1, the temperature of the fuel cell in the plane direction is not made uniform, but the temperature of the upstream portion L1 is merely made lower than that of the downstream portion L2. Thus, there is no need to cool the fuel cell 2 by a large flow rate of air, nor is a large amount of power consumed. This can prevent an inefficient operation of the system.

The method by which a flow of air is supplied by the cooling device 3 is not particularly limited. For example, the cooling device 3 can supply a certain flow rate of air constantly, or can supply a flow of air intermittently. However, detecting the temperature of the polymer electrolyte membrane 12 and controlling the flow rate of air based on the detected result is preferable in order to maximize the energy conversion efficiency of the whole system.

More specifically, if the flow rate of air supplied by the cooling device 3 is increased, the temperature of the fuel cell 2 lowers, and thus the output tends to decrease. If the temperature of the fuel cell 2 is lowered, the amount of MCO decreases. Also, if the flow rate of air supplied by the cooling device 3 is increased, the power consumption increases. Due to these reasons, if the flow rate of air supplied by the cooling device 3 is excessive, the energy conversion efficiency of the whole power supply system decreases.

As such, by adjusting the flow rate of air supplied by the air-blowing device so as to balance the decrease in the amount of MCO and the decrease in output which are caused by the temperature decrease of the fuel cell 2, it is possible to achieve the maximum energy efficiency while reducing the amount of power consumed by the air-blowing device.

For this purpose, in the system of FIG. 1, the fuel cell 2 is equipped with temperature sensors 5A and 5B for detecting the temperatures of the fuel cell 2, such as thermistors. The output signals of the temperature sensors 5A and 5B are input into the control unit 4. The control unit 4 controls the operation of the cooling device 3 based on the output signals of the temperature sensors 5A and 5B.

In reality, it is very difficult to measure the temperatures of specific portions of the polymer electrolyte membrane 12 while the fuel cell is in operation. It is thus desirable to measure the temperatures of the anode-side separator 26 of any one of the unit cells 10 included in the fuel cell 2 with the temperature sensors 5A and 5B and control the flow rate of air supplied by the cooling device 3 based on the measured result.

In the fuel cell system 1 of the illustrated example, the temperature sensors 5A and 5B detect the temperatures of the portion of the anode-side separator 26 corresponding to the upstream portion L1 (this portion is hereinafter referred to as the upstream-side portion) and the portion corresponding to the downstream portion L3 (this portion is hereinafter referred to as the downstream-side portion), respectively, of the unit cell 10 positioned in the center or center area of the fuel cell 2 in the stacking direction. When the number of unit cells is an odd number, the unit cell positioned in the center in the stacking direction, as used herein, refers to the same n^{th} unit cell when counted from both ends of the fuel cell 2 in the stacking direction.

Also, when the number of unit cells is an even number, it refers to the two unit cells which are the n^{th} unit cell and the n+1^{th} unit cell when counted from both ends in the stacking direction, their orders differing by 1. In this case, one of the two unit cells is selected to measure its temperature.

It is also possible for the control unit 4 to set the flow rate of air supplied by the cooling device 3 based on the temperatures of the upstream-side portion and downstream-side portion of the anode-side separator 26 of the outermost unit cell and the temperature difference therebetween.

With respect to the standard for air flow rate control, it is preferable to adjust the flow rate of air so that the rate of change of the temperature (temperature gradient) between the upstream-side portion of the anode-side separator 26 (the temperature therein is referred to as Tup) and the downstream-side portion of the anode-side separator 26 (the temperature therein is referred to as Tlw) in the unit cell positioned in the center of the stack is 0.2° C./cm or more. The temperature gradient is more preferably in the range of 0.2 to 1.0° C./cm. By setting the flow rate of air so that the temperature gradient is in such a range, MCO can be reduced significantly.

Generally, in the upstream portion L1 of MEA, since the methanol concentration in the fuel flow channel is high, the amount of MCO is large and the amount of heat generation is also large. On the assumption that the heat conductivity between the polymer electrolyte membrane 12 and the separators is uniform at respective positions in the plane direction of the polymer electrolyte membrane 12, the upstream portion of the MEA with large heat generation has a larger temperature difference between the polymer electrolyte membrane 12 and the anode-side separator 26.

Thus, in the case of controlling the flow rate of air by measuring the temperatures of the upstream-side portion and the downstream-side portion of the anode-side separator 26, it is necessary to consider that the polymer electrolyte membrane 12 has a larger temperature difference between the upstream portion L1 and the downstream portion L2 than the difference between the measured temperatures of the separator. This has been considered in setting the above-mentioned range of temperature gradient.

Further, by setting the upper limit for the temperature gradient of the anode-side separator 26 to 1° C./cm, partial deterioration of the electrodes (anode and cathode) can be suppressed. A more detailed description is given below. When an electrode has a large temperature difference, there is a difference in catalytic activity between a high-temperature portion and a low-temperature portion. As a result, there is a difference in the amount of power generation between the high-temperature portion and the low-temperature portion. There is thus a difference in current density therebetween. As such, by setting the temperature gradient to 1° C./cm or less, it is possible to prevent the current density of the high-temperature portion from becoming too high. It is therefore possible to suppress partial deterioration of the electrodes.

Additionally, the positions of the unit cells of the fuel cell 2 in the stacking direction are considered below. When a unit cell is disposed on the outer side in the stacking direction, heat is actively exchanged with outside, so heat is effectively dissipated. However, when a unit cell is disposed on the inner side in the stacking direction, heat dissipation is difficult. Thus, the unit cell disposed on the outer side in the stacking direction is cooled more effectively, for example, by a flow of air, than the unit cell disposed on the inner side in the stacking direction. Therefore, in the case of controlling the flow rate of air supplied by the cooling device 3 based on the temperatures detected by the temperature sensors 5A and 5B, it is necessary to consider the position of the unit cell fitted with the temperature sensors 5A and 5B in the stacking direction.

Further, generally, fuel cells have a low ability to adjust the output in response to a sharp change in load. Thus, when a fuel cell is used as a power source, the fuel cell is often combined with an auxiliary secondary battery or capacitor. This allows the output of the fuel cell to be kept constant even when the load changes in a short period of time.

When the load changes for a long period of time, operating conditions such as current density and fuel stoichiometry need to be changed. As noted above, the amount of MCO and the amount of heat generated by the MEA are significantly dependent on the amount of fuel supply. That is, the amount of MCO and the amount of heat generated by the MEA are dependent on the current generated and the fuel stoichiometry. More specifically, when the fuel stoichiometry is constant, if the current density increases, the amount of MCO and the amount of heat generated by the MEA increase. Also, when the current density is constant, if the fuel stoichiometry increases, the amount of MCO and the amount of heat generated by the MEA increase.

Therefore, it is preferable to correct the air flow rate of the cooling device 3 that has been set based on the temperatures detected by the temperature sensors 5A and 5B, according to the fuel stoichiometry. The fuel stoichiometry is calculated by the stoichiometry calculator (not shown) of the control unit 4 based on the output current of the fuel cell 2 that is adjusted so that the output voltage of the fuel cell 2 is a predetermined set voltage. The adjustment of the output current is performed, for example, by using a DC/DC converter. Further, for example, when the fuel cell is used in combination with an auxiliary secondary battery, the above-mentioned set voltage is a predetermined voltage at which power can be supplied to a load while the auxiliary secondary battery is being charged.

A more detailed description is given below. The temperature of the fuel cell 2 changes according to the balance between the amount of heat generation and the amount of heat dissipation. The heat generated by the fuel cell 2 can be determined from the amount of fuel supplied and the power generation efficiency. The power generation efficiency Pge is expressed by the following formula (5).

Pge=Futi×(voltage generated)/(theoretical voltage of DMFC)×(ΔG/ΔH) (5)

wherein ΔG is change in Gibbs free energy of whole power generation reaction and ΔH is change in entropy.

ΔG/ΔH and theoretical voltage of a DMFC is a value unique to the DMFC. Thus, the amount of heat generated by the MEA is determined by the fuel utilization rate Futi and the voltage generated. The amount Hv of heat generation can be determined by the following formula (6):

Hv=(amount of energy corresponding to amount of fuel supplied)×(1−Pge) (6)

As can be understood from the formula (6), the amount Hv of heat generation increases as the amount of fuel supply increases and the power generation efficiency Pge decreases. The amount of fuel supply is set according to the voltage, current, and fuel stoichiometry at which the intended output or efficiency can be obtained.

That is, in fuel cells, the amount of fuel supply and the power generation efficiency change constantly according to the load variation of the device to which power is supplied, the state of operation of the power supply system, etc. Thus, the amount of heat generated by the MEA also changes constantly. Therefore, in order to adjust the flow rate of air supplied by the cooling device 3 so that the temperature difference between the upstream portion and the downstream portion of the MEA is suitable, it is important to accurately detect the current value and fuel stoichiometry of the fuel cell to accurately estimate the amount of heat generated by the MEA.

More specifically, if the fuel stoichiometry is large, the flow rate of air supplied by the cooling device 3 is increased, and if the fuel stoichiometry is small, the flow rate of air supplied by the cooling device 3 is decreased.

Also, the flow rate of air can be controlled by measuring the amount of MCO during the operation of the fuel cell 2 and adjusting the flow rate of air so that the measured amount of MCO is within a suitable range. The amount of MCO can be measured by measuring the amount of unused fuel returned from the anode 14 to the mixing tank 45 with a methanol concentration sensor or the like and determining the amount of MCO from the material balance equation based on the measured result. Alternatively, it is also possible to measure the amount of carbon dioxide discharged from the cathode 16 via the mixing tank 45 by using a gas sensor and calculate the amount of MCO from the measured result.

In this case, if the amount of MCO is larger than a predetermined value, the flow rate of air can be increased, and if the amount of MCO decreases to a certain extent, the flow rate of air can be decreased for control.

Also, Embodiment 1 has been described in terms of DMFCs using methanol as the fuel, but the invention is not to be construed as being limited thereto. The invention is significantly effective when applied to all direct oxidation fuel cells using a fuel that has high affinity for water and is liquid at room temperature. Examples of such fuels include hydrocarbon liquid fuels such as ethanol, dimethyl ether, formic acid, and ethylene glycol, as well as methanol.

Also, the concentration of the aqueous methanol solution supplied to the fuel cell 2 as the fuel is preferably set to 1 mol/L to 8 mol/L. As used herein, the aqueous methanol solution supplied to the fuel cell 2 refers to the aqueous methanol solution supplied, for example, from the mixing tank 54 to the fuel cell 2 via the fuel pump 56.

By setting the concentration of the aqueous methanol solution supplied to the fuel cell 2 to 1 mol/L or more, the amount of water circulating in the fuel cell system can be reduced, thereby facilitating the reduction in the size and weight of the system. Also, by setting the concentration of the aqueous methanol solution to 8 mol/L or less, the amount of MCO can be reduced to a desirably extent easily and efficiently according to the invention. As a result, by setting the concentration of the aqueous methanol solution supplied to the fuel cell 2 in the above range, it is possible to suppress MCO in the upstream portion of the MEA and ensure that the amount of fuel supplied to the downstream portion is sufficient.

It is therefore possible to increase the fuel utilization efficiency and improve the power generation performance such as voltage generated and power generation efficiency. The more preferable concentration of the aqueous methanol solution is 3 mol/L to 5 mol/L.

The advantage of the invention is further described. As mentioned above, heightening the concentration of the aqueous methanol solution supplied to the fuel cell 2 is advantageous to reducing the size of the fuel cell system. However, if the concentration of the aqueous methanol solution is simply heightened, the amount of MCO increases, thereby resulting in decreased efficiency. Thus, there is a limit to heightening the concentration of the aqueous methanol solution. However, according to the invention, since MCO is suppressed, the amount of water circulating in the system can be reduced, compared with conventional amounts. Therefore, according to the invention, the size of the fuel cell system can be easily reduced.

### Embodiment 2

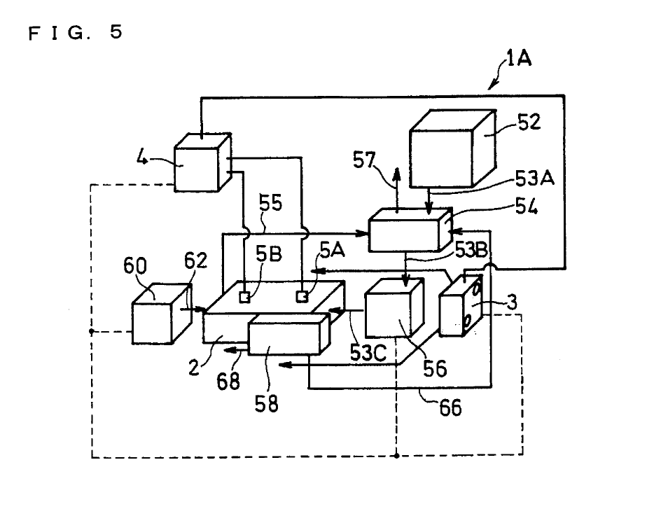

Next, Embodiment 2 of the invention is described. FIG. 5 is a schematic perspective view of the respective components of a direct oxidation fuel cell system in Embodiment 2 of the invention.

A fuel cell system 1A of FIG. 5 is different from the fuel cell system 1 of FIG. 1 in that the water collecting unit 58 is in contact with the fuel cell 2. The water collecting unit 58 is in contact with a position of the fuel cell 2 close to the upstream portion L1.

The reason why the water collecting unit 58 is brought into contact with a position of the fuel cell 2 close to the upstream portion L1 is to cool the upstream portion L1 by utilizing latent heat released when the water evaporates inside the water collecting unit 58 or in the vicinity of the gas-liquid separation film. As described above, the water collecting unit 58 temporarily stores the water produced by the fuel cell 2 for the purpose of diluting methanol.

When the amount of water in the water collecting unit 58 reaches a predetermined value or more, the flow rate of air supplied into the water collecting unit 58 and the vicinity of the gas-liquid separation film is increased to increase the amount of water evaporation, in order to prevent surplus water from overflowing, as described above. In the fuel cell system 1A of the illustrated example, the upstream portion L1 of the fuel cell 2 is effectively cooled by utilizing the latent heat released when the water evaporates inside the water collecting unit 58 or in the vicinity of the gas-liquid separation film.

The specific method for increasing the flow rate of air supplied to the water collecting unit 58 to evaporate surplus water in the water collecting unit 58 can be to temporarily increase the amount of air supplied to the cathode 16 by the air pump 60 to increase the amount of air transported to the water collecting unit 58 from the cathode 16. Alternatively, the flow of air supplied to the fuel cell 2 by the cooling device 3 can be directed into the water collecting unit 58 to increase the flow rate of air supplied to the water collecting unit 58.

Further, by disposing the water collecting unit 58 so that it contacts, for example, the side face of the fuel cell 2 corresponding to the upstream portion 1, the flow of air supplied by the cooling device 3 can be easily directed toward the gas-liquid separation film of the water collecting unit 58.

The material of the water collecting unit 58 is usually a resin such as polypropylene in view of the moldability and workability of the container. In consideration of heat conductivity for cooling, solvent resistance, and acid resistance, it is also preferable to use a carbon material having high chemical resistance or the like as the material of the water collecting unit 58. The reason why the material of the water collecting unit 58 is required to have chemical resistance is that the liquid components discharged from the cathode 16 contain a very small amount of methanol, formic acid, which is an intermediate oxide of methanol, and carbon dioxide, as well as water.

The shape of the water collecting unit 58 is usually a rectangular parallelepiped in terms of the moldability of the container. However, in terms of effectively cooling the upstream portion L1, it can also be shaped so as to surround the portion of the fuel cell 2 corresponding to the upstream portion L1 (hereinafter referred to as the upstream-side portion of the fuel cell 2). For example, it can be shaped like U when viewed from above.

Further, in a modified example of Embodiment 2, a thermoelectric device, such as, for example, a Peltier device may be disposed in place of the water collecting unit 58 so that it contacts the upstream-side portion of the fuel cell 2. In this case, the upstream portion L1 can be cooled effectively.

In this case, it is preferable to cool the thermoelectric device by a flow of air supplied by the cooling device 3. More specifically, the endothermic face of the thermoelectric device is brought into contact with the upstream-side portion of the fuel cell 2, while the exothermic face of the thermoelectric device is directed outward. The exothermic face is desirably cooled by a flow of air supplied by the cooling device 3.

Further, in order to facilitate the cooling of the upstream-side portion of the fuel cell 2, it is also possible to modify the outer shape of the fuel cell 2. For example, a radiator for promoting heat exchange, such as fins, may be installed only on the outer face of the upstream-side portion of the fuel cell 2. Also, when the fins are installed on the whole outer side of the fuel cell 2, the height of only the fins corresponding to the upstream portion may be increased.

In the case of using a cooling device capable of cooling a specific portion of the fuel cell 2 in a pinpoint manner, it is preferable to cool a portion which is close to the fuel inlet 48 and from which heat readily conducts to the fuel inlet 48. Of the portions in which MCO can occur, the fuel inlet 48 has the highest methanol concentration in the fuel flow channel 38 and generates the largest heat.

Further, even when the portion cooled by the cooling device is close to the fuel inlet 48, if there is a poor heat conductor between the cooled portion and the fuel inlet 48, the fuel inlet 48 is not sufficiently cooled. The cooling device needs to be installed in a portion where such a situation can be avoided.

Alternatively, a material with particularly good heat conduction or a mechanism for facilitating heat conduction may be disposed between the fuel inlet 48 and the cooling device. More specifically, a carbon sheet with good heat conduction, a heat pipe, etc. may be disposed.

When there are a plurality of fuel inlets 48, the portions close to all the fuel inlets 48 may be cooled. Also, when the concentration of the aqueous methanol solution is particularly high at one of the plurality of fuel inlets 48, only the portion close to that fuel inlet 48 may be cooled. Examples of the plurality of fuel inlets 48 include a case where a plurality of fuel supply devices are used to supply a fuel to the anode 14 via a plurality of paths and a case where one fuel supply device is used, but the fuel flow channel 38 branches off.

Examples of the invention are hereinafter described. However, the invention is not to be construed as being limited to the following Examples.

### Example 1

An anode catalyst material comprising anode catalyst particles supported on a conductive support was prepared. A platinum (Pt)-ruthenium (Ru) alloy (atomic ratio 1:1) with a mean particle size of 5 nm was used as the anode catalyst particles. Carbon particles with a mean primary particle size of 30 nm were used as the support. The content of the anode catalyst particles in the anode catalyst material was set to 80% by weight.

A cathode catalyst material comprising cathode catalyst particles supported on a conductive support was prepared. Platinum with a mean particle size of 3 nm was used as the cathode catalyst particles. Carbon particles with a mean primary particle size of 30 nm were used as the support. The content of the cathode catalyst particles in the cathode catalyst material was set to 80% by weight.

A 50-μm thick fluoropolymer membrane (a film composed basically of a perfluorosulfonic acid/tetrafluoroethylene copolymer (H⁺ type), trade name “Nafion® 112”, available from E.I. Du Pont de Nemours & Co. Inc.) was used as the polymer electrolyte membrane.

### (Preparation of CCM)

### (Formation of Anode)

10 g of the anode catalyst material, 70 g of a liquid dispersion containing a perfluorosulfonic acid/tetrafluoroethylene copolymer (H⁺ type) (trade name: Nafion dispersion “Nafion® 5 wt % solution”, available from E.I. Du Pont de Nemours & Co. Inc. of the United States), and a suitable amount of water were stirred and mixed with a stirring device. The resultant mixture was defoamed to prepare an ink for forming an anode catalyst layer.

The anode-catalyst-layer forming ink was sprayed onto a surface of the polymer electrolyte membrane by a spray method using an air brush, to form a rectangular anode catalyst layer of 40×90 mm. The dimensions of the anode catalyst layer were adjusted by masking. When the anode-catalyst-layer forming ink was sprayed, the polymer electrolyte membrane was adsorbed and fixed, under a reduced pressure, onto a metal plate whose surface temperature was raised to 60° C. by a heater. This allowed the anode-catalyst-layer forming ink to gradually dry during application. The thickness of the anode catalyst layer was 61 μm, and the content of the Pt—Ru alloy was 3 mg/cm².

### (Formation of Cathode)

10 g of the cathode catalyst material, 100 g of a liquid dispersion containing a perfluorosulfonic acid/tetrafluoroethylene copolymer (H⁺ type) (trade name “Nafion® 5 wt % solution” mentioned above), and a suitable amount of water were stirred and mixed with a stirring device. The resultant mixture was defoamed to prepare an ink for forming a cathode catalyst layer.

The cathode-catalyst-layer forming ink was applied onto the face of the polymer electrolyte membrane opposite to the face with the anode catalyst layer by the same method as that used to form the anode catalyst layer. In this manner, a rectangular cathode catalyst layer of 40×90 mm was formed on the polymer electrolyte membrane. The thickness of the cathode catalyst layer was 30 μm, and the content of Pt was 1 mg/cm². The anode catalyst layer and the cathode catalyst layer were disposed so that their centers (the point of intersection of diagonal lines of the rectangle) were positioned on a straight line parallel to the thickness direction of the polymer electrolyte membrane.

### (Preparation of MEA)

### (Preparation of Anode Porous Substrate)

A carbon paper subjected to a water-repellent treatment (trade name “TGP-H-090”, approximately 300 μm in thickness, available from Toray Industries Inc.) was immersed in a diluted polytetrafluoroethylene (PTFE) dispersion (trade name “D-1”, available from Daikin Industries, Ltd.) for 1 minute. The carbon paper was then dried in a hot air dryer in which the temperature was set to 100° C. Subsequently, the dried carbon paper was baked at 270° C. in an electric furnace for 2 hours. In this manner, an anode porous substrate with a PTFE content of 10% by weight was produced.

### (Preparation of Cathode Porous Substrate)

A cathode porous substrate with a PTFE content of 10% by weight was produced in the same manner as the anode porous substrate except for the use of a carbon cloth (trade name “AvCarb™ 1071HCB”, available from Ballard Material Products Inc.) in place of the carbon paper subjected to a water-repellent treatment.

### (Preparation of Anode Water-Repellent Layer)

An acetylene black powder and a PTFE dispersion (trade name “D-1” available from Daikin Industries, Ltd.) were stirred and mixed with a stirring device to prepare an ink for forming a water-repellent layer having a PTFE content of 10% by weight of the total solid content and an acetylene black content of 90% by weight of the total solid content. The water-repellent-layer forming ink was sprayed onto one surface of the anode porous substrate by a spray method using an air brush. The sprayed ink was then dried in a thermostat in which the temperature was set to 100° C. Subsequently, the anode porous substrate sprayed with the water-repellent-layer forming ink was baked at 270° C. in an electric furnace for 2 hours to remove the surfactant. In this manner, an anode water-repellent layer was formed on the anode porous substrate.

In the above manner, an anode diffusion layer comprising the anode porous substrate and the anode water-repellent layer was produced.

### (Preparation of Cathode Water-Repellent Layer)

A cathode water-repellent layer was formed on a surface of the cathode porous substrate in the same manner as the anode water-repellent layer.

In this manner, a cathode diffusion layer comprising the cathode porous substrate and the cathode water-repellent layer was produced.

The anode diffusion layer and the cathode diffusion layer were formed into a rectangle of 40×90 mm using a punching die.

Subsequently, the anode diffusion layer and the CCM were laminated so that the anode water-repellent layer was in contact with the anode catalyst layer. Also, the cathode diffusion layer and the CCM were laminated so that the cathode water-repellent layer was in contact with the cathode catalyst layer.

The resultant laminate was pressed with a pressure of 5 MPa for 1 minute, using a hot press machine in which the temperature was set to 125° C. In this manner, the anode catalyst layer and the anode diffusion layer were bonded, and the cathode catalyst layer and the cathode diffusion layer were bonded.

In the above manner, a membrane electrode assembly (MEA) comprising the anode, the polymer electrolyte membrane, and the cathode was produced.

### (Arrangement of Gasket)

A 0.25-mm thick sheet of ethylene propylene diene rubber (EPDM) was cut to a rectangle of 50 mm×120 mm. Further, a central part of the sheet was cut off to form a rectangular opening of 42 mm×92 mm. In this manner, two gaskets were prepared.

The anode was fitted into the central opening of one of the gaskets. Also, the cathode was fitted into the central opening of the other gasket.

### (Preparation of Separator)

A rectangular resin-impregnated graphite plate with a thickness of 1.5 mm and a size of 50×120 mm was prepared as a material of an anode-side separator. The surface of the graphite plate was cut to form a fuel flow channel for supplying an aqueous methanol solution to the anode. One end (short side) of the separator was provided with an inlet of the fuel flow channel. The other end (short side) of the separator was provided with an outlet of the fuel flow channel. In this manner, the anode-side separator was prepared.

Likewise, a rectangular resin-impregnated graphite plate with a thickness of 2 mm and a size of 50×120 mm was prepared as a material of a cathode-side separator. The surface thereof was cut to form an air flow channel for supplying air to the cathode as the oxidant. One end (short side) of the separator was provided with an inlet of the air flow channel. The other end (short side) of the separator was provided with an outlet of the air flow channel. In this manner, the cathode-side separator was prepared.

The grooves of the fuel flow channel and the air flow channel had a width of 1 mm and a depth of 0.5 mm in cross-section. Also, the fuel flow channel and the air flow channel were of the serpentine type capable of uniformly supplying the fuel and air to the whole anode diffusion layer and the whole cathode diffusion layer.

The anode-side separator was laminated on the MEA so that the fuel flow channel was in contact with the anode diffusion layer. The cathode-side separator was laminated on the MEA so that the air flow channel was in contact with the cathode diffusion layer.

MEAs produced in the above manner, each sandwiched between the anode-side separator and the cathode-side separator, were stacked to form 10 cells, and both ends of the stack in the stacking direction were fitted with a pair of end plates comprising 1-cm-thick stainless steel plates. A current collector plate comprising a 2-mm thick copper plate whose surface was plated with gold and an insulator plate were disposed between each end plate and each separator. The current collector plate was disposed on the separator side, while the insulator plate was disposed on the end plate side.

In this state, the pair of end plates was clamped with bolts, nuts, and springs to pressurize the MEAs and the respective separators.

In the above manner, a fuel cell (DMFC) with a size of 50×120 mm was produced.

Using the fuel cell thus produced, an experimental fuel cell system was produced. In the system, in order to heighten the accuracy of the experiment, the oxidant and the fuel were supplied to the fuel cell in such a special manner that their supply amounts could be precisely adjusted.

The oxidant was not supplied by an air pump as described in the embodiments, and instead, compressed air filled in a high pressure air cylinder was supplied by using a massflow controller of Horiba, Ltd. to adjust the flow rate thereof.

The fuel was supplied by using a precision pump (personal pump NP-KX-100 (product name)) available from Nihon Seimitu Kagaku Co. Ltd. The air-blowing device used as the cooling device was a model 412JHH available from ebm-papst of the United States.

The water collecting unit comprised a rectangular parallelepiped shaped container made of polypropylene and having a bottom face of 5×1 cm, a height of 2 cm, and an open top. A fluorocarbon resin porous film (TEMISH® of Nitto Denko Corporation), serving as the gas-liquid separation film, was thermally welded to the edge of the opening so as to close the opening.

The inlet of the fuel flow channel formed in the anode-side separator of each unit cell and the fuel pump were connected by using a silicone tube and a branched pipe. Likewise, the outlet of the fuel flow channel of each unit cell and a mixing tank were connected by using a silicone tube and a branched pipe. Also, the inlet of the air flow channel formed in the cathode-side separator of each unit cell and the massflow controller, and the outlet of the air flow channel and the water collecting unit were also connected by using a silicone tube and a branched pipe.

The fuel cell was placed in a plastic casing in the form of a rectangular tube which is open at both ends. The inner faces of the top and bottom of the casing were brought into contact with the upper and lower faces of the fuel cell (both end faces in the stacking direction of the unit cells) to prevent the air supplied by the air-blowing device from flowing therebetween. Also, a gap of 10 mm was provided between the inner faces of both sides of the casing and the outer faces of a pair of side ends of the fuel cell to form an air flow path. It should be noted that there are two pairs of side ends parallel to the stacking direction of the unit cells, and that the above-mentioned pair of side ends refer to the side ends parallel to the average flow direction of fuel (the direction of the arrow A in FIG. 3). The average flow direction of fuel is parallel with the longitudinal direction of the fuel cell. An air-blowing device was disposed so that a flow of air was supplied into the casing from the opening of the casing at the end facing the upstream-side portion of the fuel cell. As such, the upstream-side portions of the respective unit cells were first cooled by the flow of air supplied by the air-blowing device, and then the above-mentioned pair of side ends of the fuel cell was cooled.

An external power source capable of changing the voltage to be applied was used as the power source for the air-blowing device. A voltage of 7 V was applied. The temperature of the fifth unit cell from one end of the stack of 10 unit cells in the stacking direction was measured as the temperature of the fuel cell. A hole with a diameter of 1 mm and a depth of 1 cm was formed in a side portion of the anode-side separator which was exposed at each end of the fifth unit cell in the longitudinal direction thereof. A thermocouple was inserted into each of the holes to measure the temperature of the upstream-side portion (fuel inlet portion) and the temperature of the downstream-side portion (fuel outlet portion) of the fuel cell.

A 4 mol/L aqueous methanol solution was supplied to each anode as the fuel at a flow rate of 3 cm³/min. Unhumidified air was supplied to each cathode as the oxidant-containing fluid at a flow rate of 3000 cm³/min. An electronic load unit “PLZ164WA” (available from Kikusui Electronics Corporation) was connected to the output terminals of the fuel cell to adjust the output current so that the current density between the connected positive and negative terminals of the fuel cell was kept constant at 200 mA/cm².

The temperature of the fuel cell was determined by recording the temperatures measured by the respective thermocouples every 10 seconds for 1 hour from the point of time 30 minutes after the start of power generation, in order to measure the temperatures of the fuel cell in the steady state, and averaging the recorded temperatures. The amount of MCO was measured in the same manner. The details of the method for measuring the amount of MCO are described below.

The temperature of the upstream-side portion of the fuel cell measured in the above manner was 68.8° C., and the temperature of the downstream-side portion was 71.2° C. The temperature gradient between the upstream-side portion and the downstream-side portion of the fuel cell calculated from these values was 0.2° C./cm.

### Example 2

The water collecting unit was bonded to the end of the upstream-side portion of the fuel cell with a silicone adhesive. This allowed the upstream-side portion of the fuel cell to be cooled by evaporation of the water in the water collecting unit. Except for this, in the same manner as in Example 1, a fuel cell system was produced.

The temperature of the upstream-side portion of the fuel cell measured in the same manner as in Example 1 was 67.6° C. The temperature of the downstream-side portion was 71.4° C. The temperature gradient between the upstream-side portion and the downstream-side portion of the fuel cell calculated from these values was 0.32° C./cm.

### Example 3

The endothermic face of a Peltier device was bonded to the end of the upstream-side portion of the fuel cell. The Peltier device used was TEC1-01705 (product name) available from Nihon Techmo Ltd. The exothermic face of the Peltier device was supplied with a flow of air by the air-blowing device. Except for this, in the same manner as in Example 1, a fuel cell system was produced.

The temperature of the upstream-side portion of the fuel cell measured in the same manner as in Example 1 was 66.6° C. The temperature of the downstream-side portion was 71.5° C. The temperature gradient between the upstream-side portion and the downstream-side portion of the fuel cell calculated from these values was 0.41° C./cm.

### Comparative Example 1

The air-blowing device was installed so that it supplied a flow of air toward the end of the downstream-side portion of the fuel cell housed in the casing. Except for this, in the same manner as in Example 1, a fuel cell system was produced.

The temperature of the upstream-side portion of the fuel cell measured in the same manner as in Example 1 was 73.4° C. The temperature of the downstream-side portion was 66.5° C. The temperature gradient between the upstream-side portion and the downstream-side portion of the fuel cell calculated from these values was 0.58° C./cm. It should be noted that the temperature of the upstream-side portion of the fuel cell is higher than that of the downstream-side portion, and therefore that the direction of the gradient is opposite.

### Comparative Example 2

The voltage applied to the air-blowing device was increased to 12 V in order to increase the flow rate of air supplied by the air-blowing device so that the temperature of the upstream-side portion and the temperature of the downstream-side portion of the fuel cell were almost equal. Except for this, in the same manner as in Example 1, a fuel cell system was produced.

The temperature of the upstream-side portion of the fuel cell measured in the same manner as in Example 1 was 66.0° C. The temperature of the downstream-side portion was also 66.0° C. The temperature gradient between the upstream-side portion and the downstream-side portion of the fuel cell calculated from these values was 0.04° C./cm.

### [Evaluation]

Using the fuel cells of Examples 1 to 3 and Comparative Examples 1 and 2, the amount of MCO during power generation and the voltage generated were measured in a manner described below, and from the measurement results, the fuel utilization efficiency was determined. The voltage generated was measured by measuring the voltage of the input terminals of the electronic load unit “PLZ164WA” after 1 hour from the start of power generation.

### (Method for Measuring the Amount of MCO)

The gas-liquid mixture comprising carbon dioxide and the aqueous methanol solution containing unused methanol, discharged from the anode, was introduced into a gas collecting container filled with pure water, to collect gaseous and liquid methanol for 1 hour. At this time, the gas collecting container was cooled by an ice water bath.

The amount of collected methanol was measured by gas chromatography, and the amount of MCO was determined from the material balance of the anode based on the measured amount of methanol. More specifically, the amount of MCO was determined by subtracting, from the amount of methanol supplied to the anode, the amount of collected methanol and the amount of methanol consumed at the anode calculated based on the current generated. The fuel utilization rate was determined from the above formula (4).

The above results are shown in Table 1.

TABLE 1

| | Temperature | Temperature | Temperature | Voltage | Fuel | Power |
|---|---|---|---|---|---|---|
| | of upstream | of downstream | gradient | generated | utilization | generation |
| | portion (° C.) | portion (° C.) | (° C./cm) | (V) | rate (%) | efficiency (%) |
| Example 1 | 68.8 | 71.2° C. | 0.2 | 3.58 | 76.5 | 22.6 |
| Example 2 | 67.6 | 71.4 | 0.32 | 3.56 | 78.3 | 23.0 |
| Example 3 | 66.5 | 71.5 | 0.41 | 3.54 | 80.1 | 23.4 |
| Comparative | 73.4 | 66.5 | (−)0.58 | 3.21 | 70.0 | 18.6 |
| Example 1 | | | | | | |
| Comparative | 66.0 | 66.0 | 0 | 3.04 | 81.4 | 20.5 |
| Example 2 | | | | | | |

Examples 1 to 3, in which the fuel cell 2 was cooled by a flow of air so that the temperature of the upstream-side portion of the fuel cell was lower than that of the downstream-side portion, generated high voltages, compared with Comparative Examples 1 and 2. Also, Examples 1 to 3 exhibited significant improvements in fuel utilization rate, compared with Comparative Example 1. It was therefore confirmed that the amount of MCO in Examples 1 to 3 was significantly reduced, compared with Comparative Example 1. The above results confirmed that lowering the temperature of the upstream-side portion of the fuel cell was effective for heightening the voltage generated and the fuel utilization rate.

Further, in Comparative Example 1, the upstream-side portion of each unit cell, where the concentration of the aqueous methanol solution is high, had a higher temperature. Probably for this reason, it is believed that the amount of MCO further increased, thereby resulting in a fuel shortage in the downstream-side portion of the unit cell. It was thus believed that the concentration overvoltage in the downstream-side portion of each unit cell increased, thereby resulting in lower voltage.

In Examples 1 to 3, as the temperature of the upstream-side portion of the fuel cell lowered, the fuel utilization rate increased. This confirmed that cooling the upstream-side portion of the fuel cell could decrease the amount of MCO. In Example 2, in which the upstream-side portion of the fuel cell was cooled by utilizing evaporation of the water in the water collecting unit, the upstream-side portion of the fuel cell was cooled effectively, compared with Example 1, in which the other conditions than this are the same, and as a result, the fuel utilization rate was improved.

Comparative Example 2, in which the temperature of the whole fuel cell was lowered, exhibited a higher fuel utilization rate than Examples 1 to 3. Thus, the amount of MCO was also sufficiently reduced. However, Comparative Example 2 generated the lowest voltage and had a lower power generation efficiency than Examples 1 to 3. When the temperature of the fuel cell lowers, the reaction overvoltage at the electrodes increases, the proton conductivity of the polymer electrolyte membrane lowers, and the resistance to proton conductivity increases. Therefore, as the temperature of the fuel cell lowers, the voltage generated decreases. The decreased voltage lowers the power generation efficiency.

Further, in Comparative Example 2, since the voltage applied to the air-blowing device was increased to 12 V, the power consumed thereby reached 3 W. In contrast, in Examples 1 to 3 and Comparative Example 1, the voltage applied to the air-blowing device was 7 V, and the power consumed thereby was approximately 1 W.

In a fuel cell system, the power generated by the fuel cell is usually supplied to auxiliary devices such as a fuel pump, an air pump, and an air-blowing device. Thus, the effective output of the fuel cell is obtained by subtracting the power consumed by the auxiliary devices from the power generated.

On the assumption that the effective output is obtained by subtracting the power consumed by the air-blowing device from the power generated by the fuel cell, the effective output in Examples 1 to 3 is 24 W, which is obtained by subtracting 1 W from the power 25 W generated by the fuel cell. In contrast, the effective output in Comparative Example 2 is 19 W, which is obtained by subtracting 3 W from the power 22 W generated by the fuel cell.

As such, in the case of Comparative Example 2, although the fuel utilization rate is higher than those of Examples 1 to 3, the effective output of the system is lower than those of Examples 1 to 3. This suggests that Examples 1 to 3, in which the temperature of only the downstream-side portion of the fuel cell is selectively lowered, are practically advantageous.

As described above, the invention can provide high power generation performance and high fuel utilization rates, compared with conventional fuel cells, and can achieve high energy conversion efficiency.

### INDUSTRIAL APPLICABILITY

The fuel cell of the invention is useful, for example, as the power source for portable small electronic devices such as notebook personal computers, cellular phones, and personal digital assistants (PDA). The fuel cell of the invention is also applicable to uses as the power source for electric scooters and the like.

### REFERENCE SIGNS LIST

1, 1A Fuel Cell System
2 Fuel Cell
3 Cooling Device
4 Control Unit
10 Unit Cell
12 Polymer Electrolyte Membrane
14 Anode
16 Cathode
26 Anode-side Separator
36 Cathode-side Separator
38 Fuel Flow Channel
40 Air Flow Channel
46 Water collecting unit
48 Inlet
50 Outlet
52 Fuel Tank
56 Fuel Pump
60 Air Pump

1. A direct oxidation fuel cell system comprising:
a fuel cell having at least one unit cell including an anode, a cathode, and a polymer electrolyte membrane interposed therebetween, a fuel inlet portion for introducing a liquid fuel, a fuel outlet portion for discharging a fuel effluent, an oxidant inlet portion for introducing an oxidant, and an oxidant outlet portion for discharging unconsumed oxidant;
a fuel supply unit for supplying the liquid fuel to the anode through the fuel inlet portion;
an oxidant supply unit for supplying the oxidant to the cathode through the oxidant inlet portion; and
a cooling device for cooling the fuel cell so that the temperature of the fuel inlet portion is lower than that of the fuel outlet portion.

2. The direct oxidation fuel cell system in accordance with claim 1, wherein the cooling device includes an air-blowing device for supplying a flow of air in a direction from the fuel inlet portion toward the fuel outlet portion.

3. The direct oxidation fuel cell system in accordance with claim 1, further comprising an effluent collecting unit for collecting product water from the oxidant outlet portion and evaporating at least part of the collected product water to discharge it to outside,
wherein the effluent collecting unit is adjacent to a portion of the fuel cell close to the fuel inlet portion.

4. The direct oxidation fuel cell system in accordance with claim 2, further comprising:
a first temperature sensor for detecting the temperature of the fuel inlet portion;
a second temperature sensor for detecting the temperature of the fuel outlet portion; and
an air flow rate controller for setting the flow rate of air supplied by the air-blowing device according to the temperature of the fuel inlet portion and the temperature of the fuel outlet portion detected by the two temperature sensors.

5. The direct oxidation fuel cell system in accordance with claim 4, further comprising a current sensor for detecting the output current of the fuel cell,
wherein the air flow rate controller calculates fuel stoichiometry of the fuel cell based on the current value detected by the current sensor, and corrects the set flow rate of air according to the calculated fuel stoichiometry.

6. The direct oxidation fuel cell system in accordance with claim 5, further comprising a current controller for controlling the output current of the fuel cell so that the output voltage of the fuel cell is a predetermined set voltage.

7. The direct oxidation fuel cell system in accordance with claim 1, wherein the cooling device includes a Peltier device.

8. The direct oxidation fuel cell system in accordance with claim 1,
wherein the unit cell further includes an anode-side separator in contact with the anode and a cathode-side separator in contact with the cathode,
the anode-side separator has a fuel flow channel for supplying the fuel to the anode, and
the cathode-side separator has an oxidant flow channel for supplying the oxidant to the cathode.

9. The direct oxidation fuel cell system in accordance with claim 8, wherein the average flow direction of the liquid fuel in the fuel flow channel is parallel to the direction in which the flow of air is supplied by the air-blowing device.

10. A method for controlling a direct oxidation fuel cell system,
the direct oxidation fuel cell system including:
a fuel cell having at least one unit cell including an anode, a cathode, and a polymer electrolyte membrane interposed therebetween, a fuel inlet portion for introducing a liquid fuel, a fuel outlet portion for discharging a fuel effluent, an oxidant inlet portion for introducing an oxidant, and an oxidant outlet portion for discharging unconsumed oxidant;
a fuel supply unit for supplying the fuel to the anode through the fuel inlet portion; and
an oxidant supply unit for supplying the oxidant to the cathode through the oxidant inlet portion,
the method including the step (a) of cooling the fuel cell so that the temperature of the fuel inlet portion is lower than that of the fuel outlet portion.

11. The method for controlling a direct oxidation fuel cell system in accordance with claim 10, wherein the step (a) is not started until the temperature of the fuel inlet portion reaches a predetermined temperature after start of operation of the fuel cell.

12. The method for controlling a direct oxidation fuel cell system in accordance with claim 10, wherein the step (a) includes supplying a flow of air in a direction from the fuel inlet portion toward the fuel outlet portion.

13. The method for controlling a direct oxidation fuel cell system in accordance with claim 12, further comprising the step (b) of detecting the temperature of the fuel inlet portion and the temperature of the fuel outlet portion and setting the flow rate of air supplied according to the detected temperature of the fuel inlet portion and the detected temperature of the fuel outlet portion.

14. The method for controlling a direct oxidation fuel cell system in accordance with claim 13, further comprising the step (c) of calculating fuel stoichiometry of the fuel cell from the output current and correcting the set flow rate of air according to the calculated fuel stoichiometry.

15. The method for controlling a direct oxidation fuel cell system in accordance with claim 10,
wherein the unit cell further includes an anode-side separator in contact with the anode and a cathode-side separator in contact with the cathode,
the anode-side separator has a fuel flow channel for supplying the fuel to the anode,
the cathode-side separator has an oxidant flow channel for supplying the oxidant to the cathode, and
the difference between the temperature of the fuel inlet portion and the temperature of the fuel outlet portion is equal to or greater than 0.2° C./cm per unit length in the average flow direction of the fuel in the fuel flow channel.
